(19) United States
(12) Patent Application Publication
(10) Pub. No.: US 2013/0342672 A1
(43) Pub. Date: Dec. 26, 2013

(54) USING GAZE DETERMINATION WITH DEVICE INPUT

(71) Applicants: Timothy T. Gray, Seattle, WA (US); Aaron Michael Donsbach, Seattle, WA (US)

(72) Inventors: Timothy T. Gray, Seattle, WA (US); Aaron Michael Donsbach, Seattle, WA (US)

(73) Assignee: Amazon Technologies, Inc., Reno, NV (US)

(21) Appl. No.: 13/532,304

(22) Filed: Jun. 25, 2012

(51) Int. Cl. H04N 7/18

(52) U.S. Cl. 348/78; 348/E07.085

(57) ABSTRACT

A computing device, in a locked operational state, captures image information of a user which is analyzed to determine the direction of the user's gaze. When the user's gaze is determined to be substantially in the direction of the device, a predetermined input from the user, such as a tap or a voice command, will provide the user with access to at least some functionality of the device that was previously unavailable. If, however, the computing device detects what appears to be the predetermined input, but the user's gaze direction is not in the direction of the device, the computing device will remain in the locked operational state. Therefore, in accordance with various embodiments, gaze determination is utilized as an indication that the user intends to unlock at least some additional functionality of the computing device.

### BACKGROUND

People are increasingly relying upon computing devices to access various types of content, much of which can be confidential or otherwise sensitive to the user. For example, a user might store a list of personal contact information on a computing device, or might install an application that provides access to that user's bank accounts. Accordingly, it can be desirable to protect against unauthorized access to a device. In many instances, such protection requires a user to enter a password or other identifying information each time that user wants to access the device. For many users such repetitive validation can be distracting or even annoying. Thus, conventional security mechanisms must balance between user frustration at constantly entering identifying information and the level of protection for a given device.

### BRIEF DESCRIPTION OF THE DRAWINGS

Various embodiments in accordance with the present disclosure will be described with reference to the drawings, in which:

FIG. 1 illustrates an example situation in which a user is able to unlock a computing device in accordance with various embodiments;

FIG. 2 illustrates another example in which a user is able to unlock a computing device in accordance with various embodiments;

FIG. 3 illustrates another example in which a user is able to unlock a computing device in accordance with various embodiments;

FIG. 4 illustrates an example process for unlocking a computing device using gaze determination in accordance with various embodiments;

FIG. 5 illustrates a example technique for recognizing a user in accordance with various embodiments;

FIGS. 6(a)-6(c) illustrate example approaches to determining a user's gaze direction that can be used in accordance with various embodiments;

FIGS. 7(a)-7(f) illustrate example approaches to determining a user's gaze direction that can be used in accordance with various embodiments;

FIG. 8 illustrates a first portion of an example technique for performing iris recognition that can be used in accordance with various embodiments;

FIGS. 9(a) and 9(b) illustrate possible second portions of an example technique for performing iris recognition that can be used in accordance with various embodiments;

FIG. 10 illustrates an example personalized interface that can be presented to a user in response to identifying a user's identification in accordance with various embodiments;

FIG. 11 illustrates another example process for unlocking a device using gaze determination in accordance with various embodiments;

FIG. 12 illustrates an example computing device including elements operable to capture gaze information that can be used in accordance with various embodiments;

FIG. 13 illustrates example components of a computing device such as that illustrated in FIG. 12; and

FIG. 14 illustrates an environment in which various embodiments can be implemented.

### DETAILED DESCRIPTION

Systems and methods in accordance with various embodiments of the present disclosure may overcome one or more of the aforementioned and other deficiencies experienced in conventional approaches to enabling a user to interact with a computing device. In particular, various embodiments enable a user to unlock a computing device, or otherwise obtain access to functionality of that device, based at least in part upon a determined gaze direction of the user and a predetermined input, such as a tap or voice command, for example. Further, the device in at least some embodiments can perform user authentication during the unlock process in a way that is transparent to the user. Such an approach can provide secure access to the device without the need for the user to manually enter identifying information.

Conventional computing devices often include an operational state that locks at least some functionality to prevent inadvertent initiation thereof, as well as to prevent unauthorized access to data. In many instances, this state often includes a lock screen and a level of protection that requires a user to enter a password or other identifying information. The lock screen often includes information or components such as a lock screen background image, dynamic battery status, network icons, message icons, various alerts or updates, a login screen for entering a password or passcode to gain access thereto, and the like. In various embodiments, a computing device, in a locked operational state and displaying a lock screen, captures image information (e.g., still images or video) of a user. The image information is analyzed to determine the direction of the user's gaze. When the user's gaze is substantially in the direction of the computing device, a predetermined input or action from the user, such as a tap or a voice command, can cause the computing device to be unlocked, such that the user can be provided with access to at least some functionality that was previously unavailable in the locked operational state. If, however, the computing device detects what appears to be the predetermined input, but the user's gaze direction is not in the direction of the lock screen, the computing device will remain in the locked operational state. Therefore, in accordance with various embodiments, an input-gaze, or gaze-input, unlock procedure utilizes gaze determination as an indication along with a predetermined input that the user intends to unlock at least some additional functionality of the computing device.

In various embodiments, the image can be captured from an infrared (IR) sensor that detects infrared radiation reflected from the back of the user's eyes. In at least some embodiments, the computing device initiates the image capturing mode to determine the user's gaze direction when a sudden change in motion, for example, is detected by a gyroscope, an accelerometer, or other motion or proximity sensor.

Further, certain approaches provide personalized features as well as attempt to improve security by adding biometric identification. For example, a computing device can capture an image of a user and analyze the image to attempt to recognize the user using one or more facial or user recognition techniques. For example, the computing device can perform iris recognition, retina scanning, or run various facial recognition algorithms to authenticate an authorized user, thus eliminating the need for a password, among other things, such as for retrieving stored profiles of various users. Such an approach can take advantage of the obtained image information from the gaze determination to analyze biometric information for retrieving an appropriate account or settings for different users to be set up on the same device, enabling each user to select different inputs, options, and the like.

Various other applications, processes and uses are presented below with respect to the various embodiments.

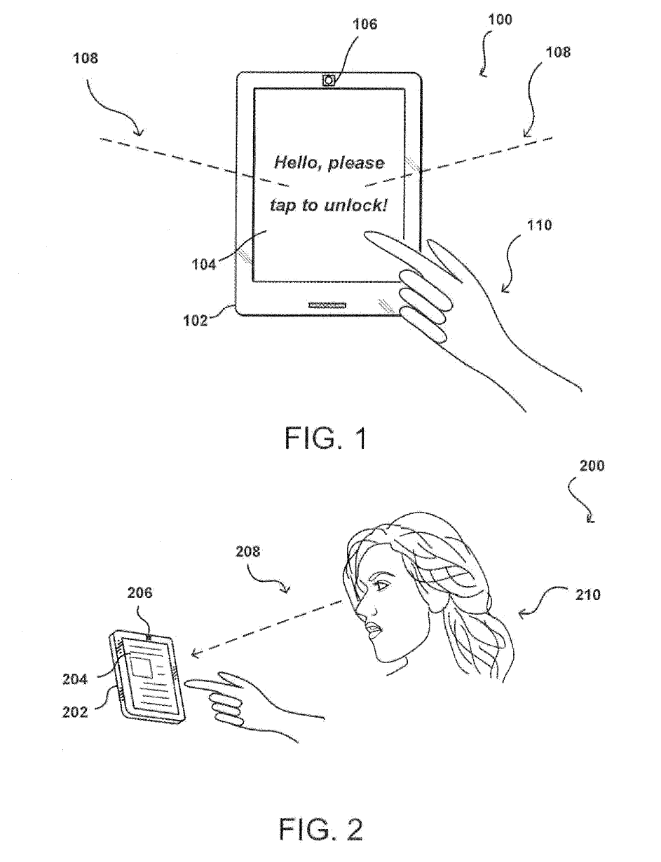

In certain conventional devices, a user can unlock a device by swiping a finger across a display screen and then enter a password or other identifying information. When the device is able to track the user's gaze, however, such an operation can be substituted, supplemented, or eliminated altogether. For instance, FIG. 1 illustrates an example situation 100 of a user 110 viewing a display element 104 of a computing device 102. In this example, the computing device 102 is in a locked operational state. While viewing the display element 104, a viewing angle or gaze direction, depicted by gaze lines 108, falls within a given range, which tends to be relative depending upon various factors, such as movement of the user or device, etc. As will be discussed in more detail later herein, the computing device 102 can be configured to detect when the user's gaze 108 is upon the display element 104 and, at which point, be able to receive a predetermined input, such as one or more taps, swipe, verbal command, air gesture, or the like, to unlock or otherwise obtain access to at least some additional functionality of the computing device 102.

In order to determine a user's gaze direction, an image capture element 106 is positioned on the computing device 102 such that the image capture element 106 is likely to be able to capture information about the user 110 as will be discussed in more detail later herein. In this example, the display element 104 presents a message to the user asking the user to “tap” to unlock the computing device 100 in response to determining the user's gaze being directed substantially toward the display element 104 (e.g., the gaze lines 108 are directed toward the display element 104 within a determined range). When the user 110 is reading the message, for example, the user's gaze 108 will be directed substantially toward the middle of the display element 104 to where the text is displayed. By determining where the user 110 is relative to the computing device 100, and the relative position of a feature of the user's eyes (e.g., a retinal reflection or a pupil/iris position), for example, an analysis of one or more images can provide an indication that the user is likely looking at that portion of the display element 104 when the eyes are in that relative orientation. The determination of the user's gaze 108 can be interpreted as confirmation of the user's intent to perform a specific action which, in this example, is unlocking the computing device 102 from the locked operational state upon receiving a predetermined input.

Accordingly, in this example the user 110 is shown tapping the display 104 thereby providing the predetermined input and unlocking the computing device 100 or otherwise providing access to at least some additional functionality that was previously unavailable in the locked operational state. Therefore, in this example, gaze determination provides the device with an indication that the user intends to unlock at least some additional functionality of the computing device upon receiving an input.

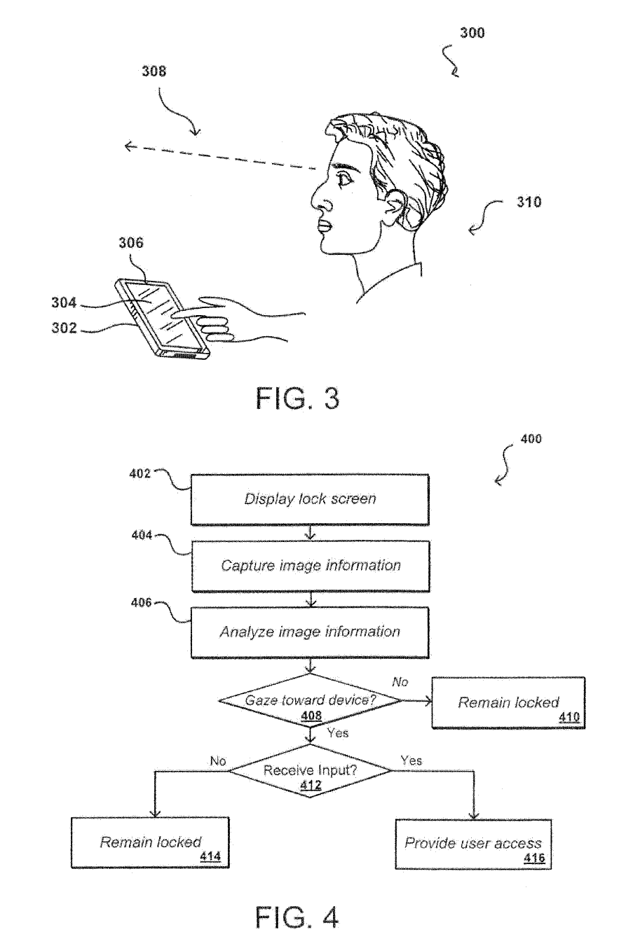

FIG. 2 illustrates an example situation 200 wherein a user 210 is viewing content on a computing device 202 that was previously in a locked operational state in accordance with one embodiment. As discussed previously, swiping a graphical element across a screen using a touch control is an approach used by many users to unlock a conventional computing device. In this example, however, the user 210 can unlock the computing device 200 by providing a “tap” gesture to a touch screen 204 while looking substantially in the direction of the touch screen 204, as depicted by the user's gaze lines 208. If, however, the computing device 200 detects what appears to be a “tap” gesture, but the user's gaze is somewhere other than the screen 204, as will be discussed further with respect to FIG. 3, the computing device 200 will remain locked, unless the user had provided another unlock mechanism, such as a conventional swipe or PIN entry. Therefore, in this example, gaze determination provides the computing device with an indication that the user intends to unlock at least some additional functionality of the computing device.

FIG. 3 illustrates an example situation 300 wherein a user 310 is providing a predetermined touch gesture to a computing device 302 in a locked operational state in accordance with one embodiment. Although the user 310, in this example, is providing the predetermined touch gesture to a touch screen 304, the screen is blank and the device is not responding because the user is not looking in the direction of the computing device 302. In this example, the user's gaze 308 is directed elsewhere and not in a direction the computing device 302, thus, the computing device 302 has not received the indication that the user 310 intended to unlock the device even in the presence of, what appears to be, the predetermined touch gesture. Therefore, in this example, the absence of the user's gaze 308 upon the touch screen 304 or substantially in the direction of the computing device 302, does not provide the device with both indications that the user intended to unlock at least some additional functionality of the computing device 302 using a input-gaze, or gaze-input, unlock procedure.

In one embodiment, a computing device can be unlocked from a locked operational state simply when a user is looking at the computing device without requiring the predetermined touch gesture or input. Thus, the computing device would be locked when the user is looking away and unlocked once the user is looking at the device. To the same end, the computing device does not necessarily need to be in a locked operational state. Put differently, the computing device could be configured to accept input from a user when the user is looking at the computing device, or when the computing device determines that the user's gaze direction intersects the display of the computing device, and be unable to accept input when the user is looking away.

Various triggers or queues can be used for initiating gaze determination. In one embodiment, an image capturing mode to determine a user's gaze direction can be triggered when the computing device detects a change in movement from one or more motion sensors, such as a gyroscope or accelerometer. In this example, the message can be displayed to the user when the image capture mode is initiated or upon determining the user's gaze being directed substantially toward the display element. Alternatively, the image capturing mode could be initiated when a light sensor detects a change in lighting such, as when a user pulls out a device from a pocket or purse. For example, a non-illuminated device or a device in a power saving mode could be “woken up” when a particular action is detected that suggests that the user is going to engage the device, such as by lifting the device and angling it in a position for viewing. In another embodiment, the image capturing mode could be continuous or substantially continuous depending on certain factors, such as battery life and time of day, such as during the day when the user is presumably awake. In another embodiment, the image capturing mode is initiated whenever the computing device is locked and/or detected to be in a particular situation, such as when the device is determined to be held by a user. Other modes or circumstances of display are possible as well.

FIG. 4 illustrates an example of a process 400 for an input-gaze, or gaze-input, unlock procedure that can be utilized in accordance with various embodiments. It should be understood that, for any process discussed herein, there can be additional, fewer, or alternative steps performed in similar or alternative orders, or in parallel, within the scope of the various embodiments unless otherwise stated. In this example, a lock screen is displayed on a display element of a computing device 402. The lock screen of various embodiments disables various functionality, or locks that functionality, from being inadvertently triggered, opened, launched, accessed, or otherwise initiated. Typically, a lock screen includes elements such as a lock screen background image, battery status, network icons, message and alert banners, and the like. In this example, image information is captured using at least one image capture element of the computing device 404. The image information is analyzed to determine a gaze direction of a user with respect to the display element 406. In various embodiments, the lock screen can prompt the user for a predetermined input upon determining that the user's gaze direction is directed substantially toward the display element. In other embodiments, the device can display the lock screen and be ready for the predetermined input without prompting the user. In this example, if it is determined 408 that the gaze direction of the user is not directed toward the computing device, the screen remains locked 410. However, in this example, if it is determined 408 that the user's gaze direction is substantially in the direction of the computing device, the computing device checks or determines whether the user provided the predetermined input 412. If the user did not provide the predetermined input, the computing device continues to remain locked 414. However, in this example, if the user did provide the predetermined input, the user is provided with access to at least some additional functionality of the computing device 416. It should be understood that the order of process steps 408 and 412 can be interchanged in various embodiments or these process steps could be performed in parallel.

In at least some embodiments, a computing device can distinguish between a “gaze” and a “glance” based at least in part upon the amount of time at which the user's view dwells at a specific location. For example, a device might not make itself unlockable when the user is determined to be engaged in a eye gesture referred to herein as “glancing” substantially in the direction of the device, wherein the gaze direction of the user is determined to be substantially towards a location for a relatively short period of time (e.g., less than a minimum threshold amount of time). If a user looks substantially in the direction of a display element of the device and then looks away in less than half a second, for example, the user might be determined to have glanced at that area and the device will remain locked and unavailable for input. If the user continues to direct the gaze direction substantially in the display element for a longer period of time, referred to herein as “gazing”, the device can make itself open for input and subsequent unlock.

Various embodiments can take advantage of the fact that devices are increasingly equipped with imaging elements such as cameras or infrared sensors, and thus can capture image information of a user of the device. As described above, this image information can be analyzed to determine a relative viewing location or gaze direction of a user. In addition, the image information can be analyzed to determine biometric information to provide users with various personalized features as well as be utilized to improve security by authenticating individual users. For example, a device can capture image information of a user in an attempt to recognize the user using facial recognition, iris recognition, retina scanning, and like. When identity information of a user is identified through facial recognition, iris recognition, retina scanning, reading signature, login, or other such information, an appropriate model can be used to customize the interface and/or adjust the control scheme for a particular user. Accordingly, various example techniques for determining the gaze direction and identity information of a user are described.

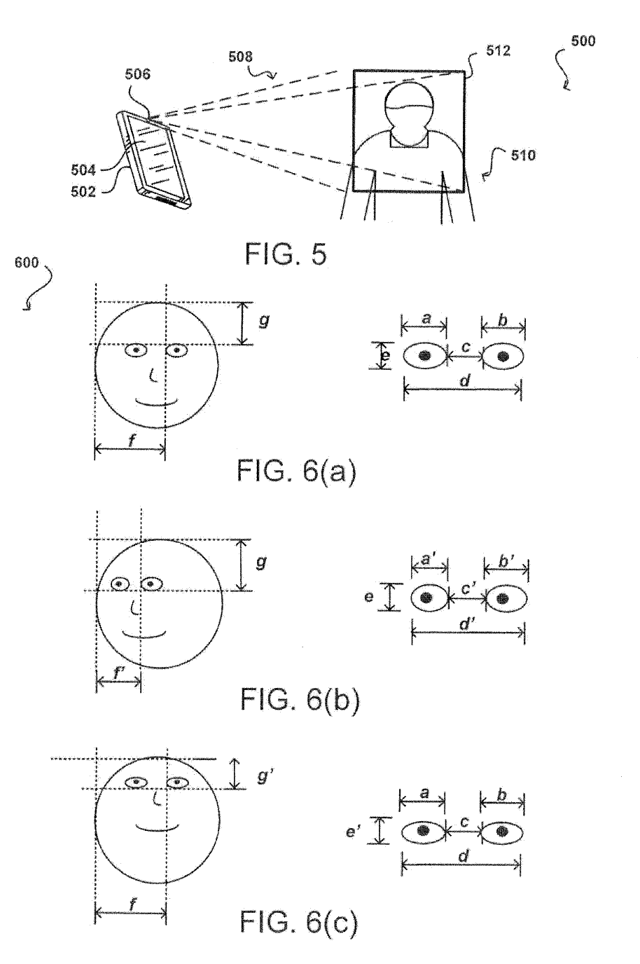

In order to determine the gaze direction of a user, the device in at least some embodiments has to determine the relative position of the user relative to the device, as well as dimensions or other aspects of the user at that position. For example, FIG. 5 shows a computing device 504 that includes one or more cameras or other such capture elements 506 operable to perform functions such as image and/or video capture. The image capture elements 506 may be, for example, a camera, a charge-coupled device (CCD), a motion detection sensor, or an infrared sensor, and the like. In FIG. 5, the head of a user 502 is positioned within a field of view 512 of one of the image capturing elements 506. In this example, the computing device 504 captures one or more images of the user's face to analyze using a facial recognition process or other such application that is operable to locate the user's face and/or various landmarks or features that can be helpful in identifying the user. In at least some embodiments, the relative locations of these features can be compared to a library or set of facial feature locations for one or more users, in order to attempt to match the relative features locations with the stored feature locations of the user 502. Various pattern or point matching algorithms can be used for such processes as known in the art. If the relative point distribution, or other such data set, matches the information for a user with at least a minimum level of confidence, the user can be authenticated to the device (assuming the identified user matches any information manually provided by the user, for example). In at least some embodiments, head tracking can be used to reduce the amount of image information that must be analyzed in accordance with various embodiments, in order to reduce the amount of resources needed for the processing, etc.

FIG. 6(a) illustrates an example 600 wherein images are captured and analyzed to determine the relative positions of the user's head and the user's eyes. In a system wherein the algorithm is able to differentiate the user's pupils, the system can also utilize the relative position of the pupils with respect to the eye position. For example, FIG. 6(b) illustrates a case where the user is looking “left” (or to the user's “right”), such that a center point of each user's pupil is to the left (in the image) of the center point of the respective eye. Similarly, FIG. 6(c) illustrates a case where the user is looking “up”. As can be seen, the positions of the pupils have moved above a center point of the eyes. The position of the pupils can change without the user moving his or her head. Thus the system may be able to, in some embodiments, detect a glance or gaze without a change in head position. A system can also detect movements such as a user closing his or her eyes for an extended period of time, wherein the device can perform an action such as placing an electronic book reader, for example, in a “sleep” or power-limiting mode, deactivating image capture, or powering off the device. A system in some embodiments can differentiate between different types of movement, such as between eye tremor, smooth tracking, and ballistic movements.

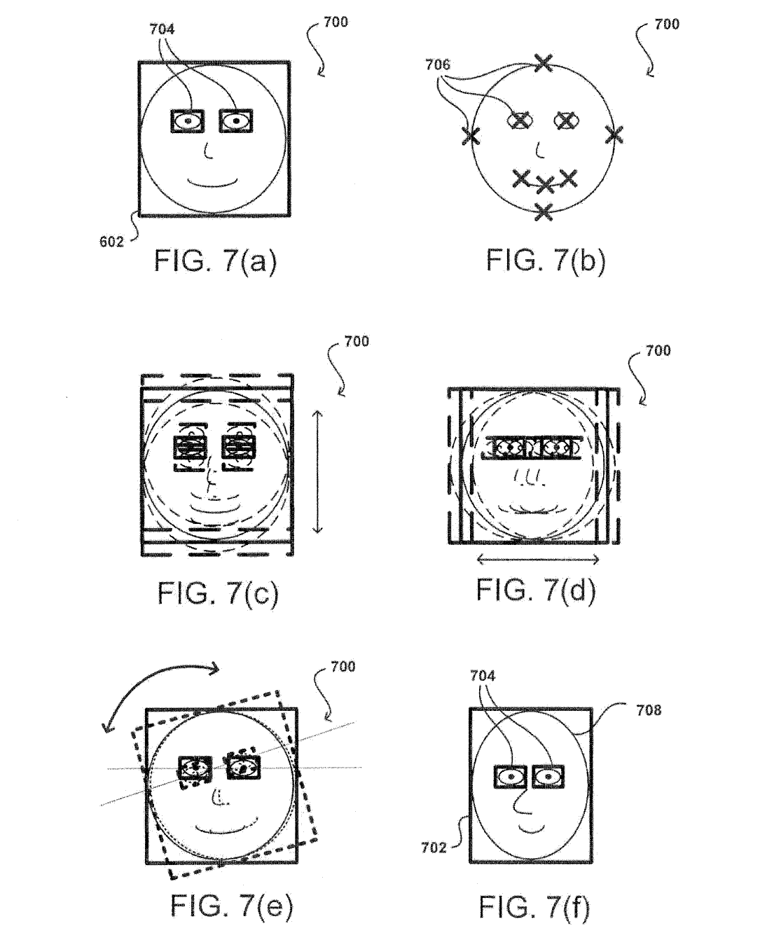

Another example technique that can be used in determining the gaze direction of a user us described with respect to FIGS. 7(a)-7(f). In this example, various approaches attempt to locate one or more desired features of a user's face to determine various useful aspects for determining the relative orientation of a user. For example, an image can be analyzed to determine the approximate location and size of a user's head or face. FIG. 7(a) illustrates an example wherein the approximate position and area of a user's head or face 700 is determined and a virtual “box” 702 is placed around the face as an indication of position using one of a plurality of image analysis algorithms for making such a determination. Using one algorithm, a virtual “box” is placed around a user's face and the position and/or size of this box is continually updated and monitored in order to monitor relative user position. Similar algorithms can also be used to determine an approximate location and area 704 of each of the user's eyes (or in some cases the eyes in tandem). By determining the location of the user's eyes as well, advantages can be obtained as it can be more likely that the image determined to be the user's head actually includes the user's head, and it can be determined whether the user is gazing at the computing device. Further, the relative movement of the user's eyes can be easier to detect than the overall movement of the user's head when performing motions such as nodding or shaking the head back and forth.

Various other algorithms can be used to determine the location of features on a user's face. For example, FIG. 7(b) illustrates an example method where various features on a user's face are identified and assigned a point location 706 in the image. The system thus can detect various aspects of a user's features Such an approach provides advantages over the general approach of FIG. 7(a) in certain situations, as various points along a feature can be determined, such as the end points and at least one center point of a user's mouth.

Once the positions of facial features of a user are identified, relative motion between the user and the device can be detected. For example, FIG. 7(c) illustrates an example where the user's head 600 is moving up and down with respect to the viewable area of the imaging element. As discussed, this could be the result of the user shaking his or her head, or the user moving the device up and down, etc. FIG. 7(d) illustrates a similar example wherein the user is moving right to left relative to the device, through movement of the user, the device, or both. As can be seen, each movement can be tracked as a vertical or horizontal movement, respectively, and each can be treated differently. As should be understood, such a process also can detect diagonal or other such movements. FIG. 7(e) further illustrates an example wherein the user tilts the device and/or the user's head, and the relative change in eye position is detected as a rotation. In some systems, a “line” that corresponds to the relative position of the eyes can be monitored, and a shift in angle of this line can be compared to an angle threshold to determine when the rotation should be interpreted.

FIG. 7(f) illustrates another advantage of using an approach such as that described with respect to FIG. 7(b) to determine the position of various features on a user's face. In this exaggerated example, it can be seen that the features of a second user's head 708 have a different relative position and separation. Thus, the device also can not only determine positions of features for a user, but can distinguish between different users. As discussed later herein, this can allow the device to perform differently for different users. Also, the device can be configured to detect how close a user is to the device based on, for example, the amount and ratio of separation of various features, such that the device can detect movement towards, and away from, the device. This can help to improve the accuracy of gaze detection.

As mentioned above, using gaze tracking to unlock the device can also provide various devices with the ability to identify a user based upon the captured image information. For example, the captured image information can be used to identify features of the user's eyes, such as unique points on a user's iris or retina that can be used to identify that user. Such information can be used with the gaze-input, or input-gaze, unlock procedure to provide a secure unlock mechanism that does not require the physical or manual entry of identifying information such as a password or passcode.

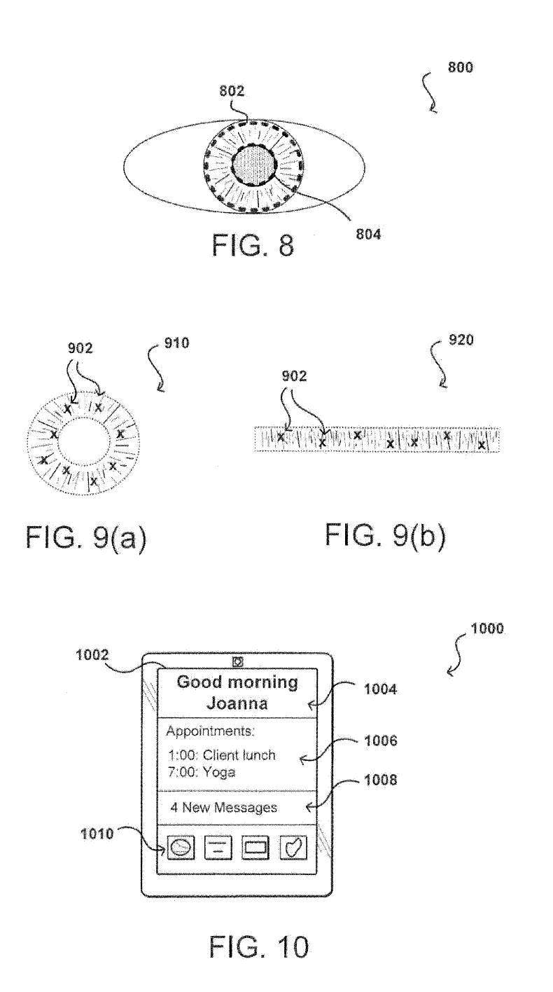

In one example, FIG. 8 illustrates an example of information captured for a human eye 800, where the basic shape of the eye is utilized to locate an approximate outer boundary 802 and inner boundary 804 of the eye. In some embodiments this will be done for only one of the user's eyes, to reduce processing requirements and increase the recognition speed, while in other embodiments both eyes might be analyzed for improved accuracy, as may be needed for more secure applications. In some embodiments, the information captured for a second eye will only be analyzed if the results for the first eye are inconclusive or if there is a problem with the analysis of the first eye, etc. Various algorithms or settings can be used to determine which eye to analyze, such as may be based upon lighting, relative angle, etc.

Once the portion of the image corresponding to the iris is identified, a matching or feature location process can be used to attempt to identify the user. In FIG. 9(a), for example, unique or distinctive features 902 of the iris can be determined using any appropriate biometric feature determination process known or used for such purposes. In other processes, an image matching process might be used to instead attempt to identify the user, but such image matching can be relatively processor and/or memory intensive such that it can be desirable for certain devices, such as portable devices, to instead attempt to identify unique features, which then instead enables the device to match based upon a relatively small set of data points. FIG. 9(b) illustrates another example of iris information 920 wherein the iris information is adjusted to a substantially linear set of feature points, which can simplify the matching in at least some embodiments while still providing acceptably reliable results.

As mentioned above, the ability to recognize a user enables the device to provide the user with any personalized content or functionality known or used for various devices in response to a user authentication. For example, FIG. 10 illustrates an example welcome screen that can be displayed on a display element 1002 of a computing device 1000 in response to a user being recognized and/or authenticated as part of a gaze monitoring process in accordance with one of the various embodiments. In this example, the welcome screen displays a personalized message to the recognized user 1004, as well as personalized information such as schedule information 1006 and information indicating messages received for that user 1008. The device can also display specific applications 1010 or other elements or functionality selected by or otherwise associated with that user. Various other types of personalization can be utilized as well as known in the art.

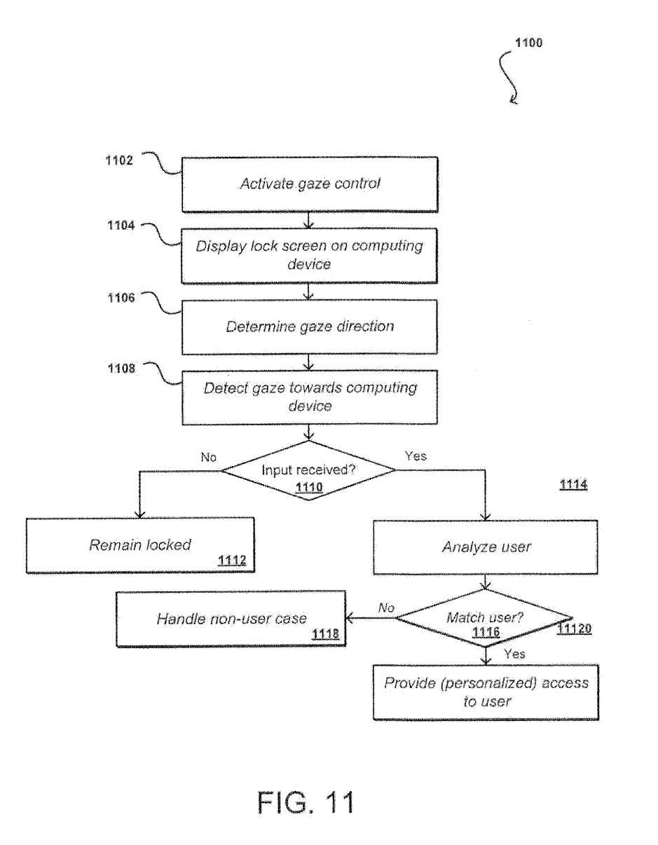

Accordingly, FIG. 11 illustrates an example process 1100 for unlocking a device using gaze determination that utilizes user identification in accordance with various embodiments. As mentioned above with respect to FIG. 4, it should be understood that, for any process discussed herein, there can be additional, fewer, or alternative steps performed in similar or alternative orders, or in parallel, within the scope of the various embodiments unless otherwise stated. In this example, a user's gaze is tracked or monitored in a gaze tracking mode by a computing device 1102. In some embodiments a user must activate this mode manually, while in other modes the device can activate the mode whenever the computing device is locked and/or detected to be in a particular situation, such as when the device is determined to be held by a user, when the device is moved or a motion detector detects nearby movement, etc. Other modes of activation are possible as well. When gaze tracking is active, the device can capture image information around the device to attempt to locate a person nearby. If a person is detected, the device (or a system or service in communication with the device) can attempt to locate that user's eyes, and determine the viewing location and/or gaze direction of that person. In this example, a lock screen is displayed on a display of the computing device 1104. In some embodiments, the lock screen is displayed when the gaze tracking is activated. In one embodiment, a gyroscope and/or accelerometer could detect an action indicating that the user just pulled the device from a pocket or purse and automatically illuminates or displays information on the lock screen to “wake up” the device. For example, a non-illuminated device or a device in a power saving mode could be “woken up” when a particular action is detected that suggests that the user is going to engage the device, such as by lifting the device and angling it in a position for viewing. In one instance, a light sensor could be used instead of or in addition to the gyroscope and/or accelerometer to determine a user's readiness to engage the device. For example, the device could remain “asleep” in the dark and be “woken up” when the light sensor detects light such as when a user pulls the device out of a purse or pocket. Other modes or circumstances of display are possible as well.

In this example, the computing device attempts to determine the user's gaze direction 1106. When a user wants to unlock or otherwise gain access to the computing device, the device will detect the user's gaze direction to likely be substantially toward the display. Accordingly, in this example, the user's gaze is detected to be substantially toward the display of the computing device 1108. In some embodiments, detecting the gaze being towards the device can cause other actions to be performed as well, such as to activate a display element, connect to a nearby network, or otherwise activate functionality or elements that might have been at least temporarily turned off or placed into a low power mode for resource savings or other such purposes.

When the user is determined to be gazing substantially at the display, in this example, the computing device can check or determine whether a user has provided a predetermined input 1110. The predetermined input can be at least one of a tap, a swipe, a voice command, or an air gesture either made with the device itself or made by a user's hand in view of the computing device's image capturing element. It should be understood that the computing device could determine whether the user provided the predetermined input first, and then determine the user's gaze direction. In this example, if the user did not provide the predetermined input, the computing device will remain locked 1112. In at least some embodiments, the user will have other mechanisms for unlocking the device instead, such as by entering a passcode or using other approaches.

If the gaze direction is substantially directed toward the display of the computing device within an acceptable range of deviation and the user has provided the predetermined input, the device can use the captured image information to determine the user's identity by performing one or more of iris recognition, retina scanning, facial recognition, and the like from the captured image information 1114 at or around the time when the direction of the user's gaze is determined. Other methods, algorithms, or techniques for determining identity are also possible. A matching process can be used to attempt to match the identity characteristics or results from one or more of the iris recognition, retina scanning, or facial recognition of the user to a known and/or authorized user 1116 stored on the computing device or in a remote server in communication therewith. If no match is located, a non-user case can be handled 1120, such as where the person is not able to unlock the device or at least obtain certain functionality of the device. If a user match is determined, and that user is authorized to access at least certain functionality on the device, that user can be provided with access (that might be personalized or limited) to the device 1122. If at some point the device becomes locked again, at least a portion of the process can be repeated as needed.

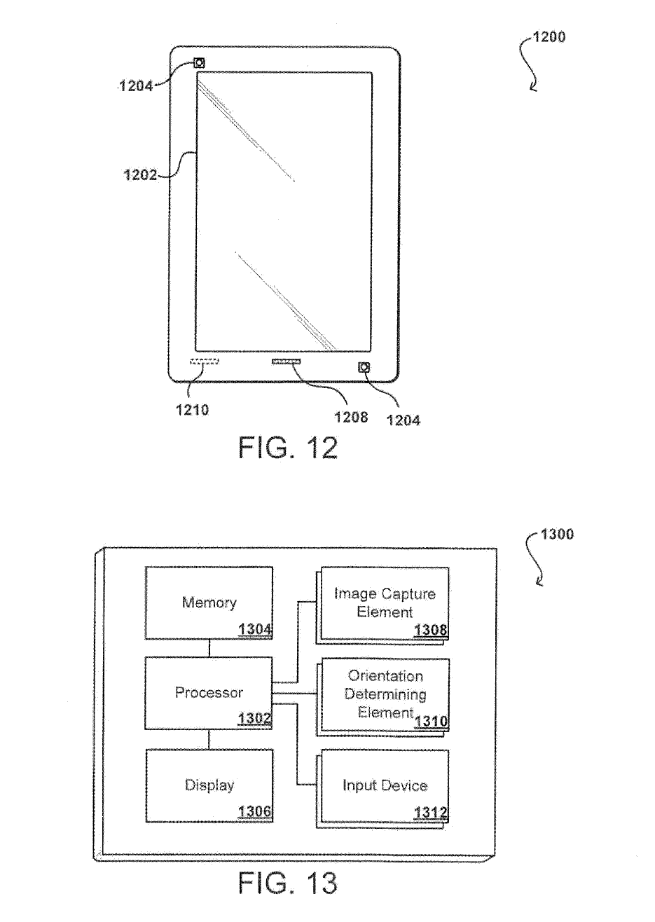

FIG. 12 illustrates an example of a computing device 1200 that can be used in accordance with various embodiments. Although a portable computing device (e.g., a smart phone, an electronic book reader, or tablet computer) is shown, it should be understood that any device capable of receiving and processing input can be used in accordance with various embodiments discussed herein. The devices can include, for example, desktop computers, notebook computers, electronic book readers, personal data assistants, cellular phones, video gaming consoles or controllers, televisions, television remotes, television set top boxes, and portable media players, among others.

In this example, the computing device 1200 has a display screen 1202, which under normal operation will display information to a user facing the display screen (e.g., on the same side of the computing device as the display screen). The computing device in this example can include one or more image capture elements, in this example including two image capture elements 1204 on the front side of the device, although it should be understood that image capture elements could also, or alternatively, be placed on the sides or corners of the device, and that there can be any appropriate number of capture elements of similar or different types. Each image capture element 1204 may be, for example, a camera, a charge-coupled device (CCD), a motion detection sensor, or an infrared sensor, or can utilize any other appropriate image capturing technology. The computing device can also include at least one microphone 1208 or other audio capture element(s) capable of capturing other types of input data. At least one orientation-determining element 1210 can be used to detect changes in position and/or orientation of the device. Various other types of input can be utilized as well as known in the art for use with such devices.

FIG. 13 illustrates a set of basic components of a computing device 1300 such as the device 500 described with respect to FIG. 12. In this example, the device includes at least one processor 1102 for executing instructions that can be stored in a memory device or element 1304. As would be apparent to one of ordinary skill in the art, the device can include many types of memory, data storage or computer-readable media, such as a first data storage for program instructions for execution by the processor 1302, the same or separate storage can be used for images or data, a removable memory can be available for sharing information with other devices, and any number of communication approaches can be available for sharing with other devices. The device typically will include some type of display element 1306, such as a touch screen, electronic ink (e-ink), organic or inorganic light emitting diode (OLED and LED) or liquid crystal display (LCD), although devices such as portable media players might convey information via other means, such as through audio speakers. As discussed, the device in many embodiments will include at least two image capture elements 1108, such as at least two cameras or detectors that are able to image a user, people, or objects in the vicinity of the device. It should be understood that image capture can be performed using a single image, multiple images, periodic imaging, continuous image capturing, image streaming, etc. The device also can include one or more orientation and/or location determining elements 1310, such as an accelerometer, gyroscope, electronic compass, or GPS device as discussed above. These elements can be in communication with the processor in order to provide the processor with positioning, movement, and/or orientation data.

The device can include at least one additional input device 1312 able to receive conventional input from a user. This conventional input can include, for example, a push button, touch pad, touch screen, wheel, joystick, keyboard, mouse, trackball, keypad or any other such device or element whereby a user can input a command to the device. These I/O devices could even be connected by a wireless infrared or Bluetooth or other link as well in some embodiments. In some embodiments, however, such a device might not include any buttons at all and might be controlled only through a combination of visual and audio commands such that a user can control the device without having to be in contact with the device.

In some embodiments, the computing device can store matching information for each user of that device, such that the matching and/or authentication process can be performed on the device. In other embodiments, the image and/or feature information can be sent to a remote location, such as a remote system or service, for processing. In some embodiments, a device can include an infrared detector or motion sensor, for example, which can be used to activate gaze tracking, display the lock screen, or various other operational modes.

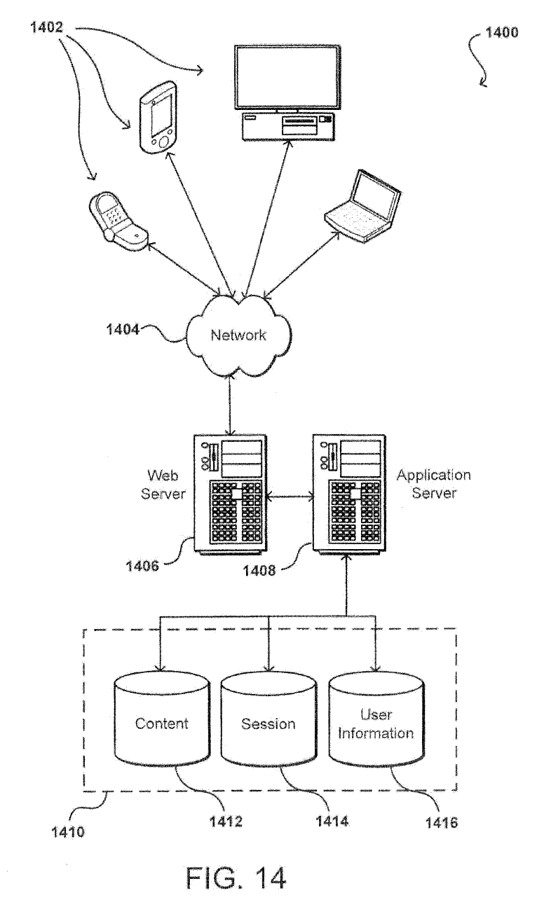

As discussed, different approaches can be implemented in various environments in accordance with the described embodiments. For example, FIG. 14 illustrates an example of an environment 1400 for implementing aspects in accordance with various embodiments. As will be appreciated, although a Web-based environment is used for purposes of explanation, different environments may be used, as appropriate, to implement various embodiments. The system includes an electronic client device 1402, which can include any appropriate device operable to send and receive requests, messages or information over an appropriate network 1404 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server 1406 for receiving requests and serving content in response thereto, although for other networks, an alternative device serving a similar purpose could be used, as would be apparent to one of ordinary skill in the art.

The illustrative environment includes at least one application server 1408 and a data store 1410. It should be understood that there can be several application servers, layers or other elements, processes or components, which may be chained or otherwise configured, which can interact to perform tasks such as obtaining data from an appropriate data store. As used herein, the term “data store” refers to any device or combination of devices capable of storing, accessing and retrieving data, which may include any combination and number of data servers, databases, data storage devices and data storage media, in any standard, distributed or clustered environment. The application server 1408 can include any appropriate hardware and software for integrating with the data store 1410 as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server 1406 in the form of HTML, XML or another appropriate structured language in this example. The handling of all requests and responses, as well as the delivery of content between the client device 1402 and the application server 1408, can be handled by the Web server 1406. It should be understood that the Web and application servers are not required and are merely example components, as structured code discussed herein can be executed on any appropriate device or host machine as discussed elsewhere herein.

The data store 1410 can include several separate data tables, databases or other data storage mechanisms and media for storing data relating to a particular aspect. For example, the data store illustrated includes mechanisms for storing content (e.g., production data) 1412 and user information 1416, which can be used to serve content for the production side. The data store is also shown to include a mechanism for storing log or session data 1414. It should be understood that there can be many other aspects that may need to be stored in the data store, such as page image information and access rights information, which can be stored in any of the above listed mechanisms as appropriate or in additional mechanisms in the data store 1410. The data store 1410 is operable, through logic associated therewith, to receive instructions from the application server 1408 and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device 1402. Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 14. Thus, the depiction of the system 1400 in FIG. 14 should be taken as being illustrative in nature and not limiting to the scope of the disclosure.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other computing devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS and AppleTalk. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Perl, Python or TCL, as well as combinations thereof. The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method comprising:
under the control of one or more computer systems configured with executable instructions,
capturing an image of at least a portion of a user using a camera of a computing device;
analyzing, using a processor of the computing device, the image to determine a gaze direction of the user;
detecting a touch gesture from the user on a touch screen of the computing device; and
causing the computing device to change from a locked operational state to an unlocked operational state when the gaze direction of the user intersects the display screen during detection of the touch gesture.

2. The method of claim 1, wherein the touch gesture is at least one of a tap or a swipe on the touch screen of the computing device.

3. The method of claim 1, wherein the camera includes at least one infrared (IR) sensor operable to detect light reflected by the user from at least one IR emitter of the computing device.

4. The method of claim 1, further comprising:
performing at least one of iris recognition, retina scanning, or facial recognition to determine whether information representative of at least one of the user's eyes matches information stored for an authorized user.

5. A method comprising:
under the control of one or more computer systems configured with executable instructions,
determining a gaze direction of a user by analyzing one or more images captured using at least one camera of a computing device;
receiving an input to the computing device; and
causing the computing device to change from a locked operational state to an unlocked operational state when the gaze direction of the user is toward the computing device when the input to the computing device is received.

6. The method of claim 5, wherein the computing device is at least one of a desktop computer, a notebook computer, a tablet computer, an electronic book reader, a smartphone, a video gaming console or controller, a television, a television remote, a television set top box, or a portable media player.

7. The method of claim 5, wherein the at least one camera includes at least one infrared (IR) sensor operable to detect light reflected by the user from at least one IR emitter of the computing device.

8. The method of claim 5, further comprising:
activating an image capturing mode to determine the gaze direction of the user when at least one of a gyroscope or an accelerometer detect a change in motion.

9. The method of claim 5, wherein the input is at least one of a voice command, an air gesture, a tap on a touch screen of the computing device, or a swipe on the touch screen of the computing device.

10. The method of claim 5, wherein determining a gaze direction includes initiating an image capture sequence of the computing device, wherein the initiating is configured to occur periodically, in response to receiving input from an accelerometer, or in response to a change in lighting.

11. The method of claim 5, further comprising:
performing at least one of iris recognition, retina scanning, or facial recognition to determine whether information representative of at least one of the user's eyes matches information stored for an authorized user.

12. A method comprising:
under the control of one or more computer systems configured with executable instructions,
capturing image information of a user using at least one camera of a computing device to determine an identity and a gaze direction of the user;
displaying a lock screen image on a display screen of the computing device; and
when a predetermined input is received from the user while the gaze direction intersects the computing device, causing the computing device to change from a locked operational state to an unlocked operational state.

13. The method of claim 12, wherein the predetermined input is at least one of a voice command, an air gesture, a tap, or a swipe on a touch screen of the computing device.

14. The method of claim 13, wherein the computing device ignores input from the user when the gaze direction of the user is not toward the computing device.

15. The method of claim 13, wherein the computing device includes at least one infrared (IR) sensor operable to detect light reflected by the user from at least one IR emitter of the computing device.

16. A computing device, comprising:
a device processor;
a display screen; and
a memory device including instructions operable to be executed by the processor to perform a set of actions, enabling the computing device to:
determine a gaze direction of a user by analyzing one or more images captured using at least one camera of the computing device; and
cause the computing device to change from a locked operational state to an unlocked operational state when the gaze direction of the user is toward the computing device.

17. The computing device of claim 16, wherein the at least one camera includes at least one infrared (IR) sensor operable to detect light reflected by the user from at least one IR emitter of the computing device.

18. The computing device of claim 16, wherein the computing device ignores input from the user when the gaze direction of the user is not toward the computing device.

19. The computing device of claim 16, wherein the computing device is at least one of a desktop computer, a notebook computer, a tablet computer, an electronic book reader, a smartphone, a video gaming console or controller, a television, a television remote, a television set top box, or a portable media player.

20. A non-transitory computer-readable storage medium storing instructions that, when executed by a processor, cause the processor to:
determine a gaze direction of a user by analyzing one or more images captured using at least one camera of the computing device;
receive an input to the computing device; and
cause the computing device to change from a locked operational state to an unlocked operational state when the gaze direction of the user is toward the computing device when the input to the computing device is received.

21. The non-transitory computer-readable storage medium of claim 20, wherein the input is at least one of a voice command, an air gesture, a tap, or a swipe on a touch screen of the computing device.

22. The non-transitory computer-readable storage medium of claim 20, wherein determining the gaze direction of the user includes analyzing the one or more images to determine a relative position of the user with respect to the computing device and a relative location of at least one portion of at least one eye of the user.

23. The non-transitory computer-readable storage medium of claim 20, wherein the instructions when executed further cause the processor to:
perform at least one of iris recognition, retina scanning, or facial recognition to determine whether information representative of at least one of the user's eyes matches information stored for an authorized user.

24. The non-transitory computer-readable storage medium of claim 23, wherein the instructions when executed further cause the processor to:
block access to the at least some functionality when the information representative of the at least of the user's eyes does not match information stored for the user or another authorized user.

25. The non-transitory computer-readable storage medium of claim 24, wherein the instructions when executed further cause the processor to:
personalize at least one aspect of an interface executing on the computing device in response to the information representative of the at least one of the user's eyes matching information stored for the user or the another authorized user, personalization information being associated with at least one of the user or the another authorized user.
